(19) United States
(12) Patent Application Publication
(10) Pub. No.: US 2026/0115725 A1
(43) Pub. Date: Apr. 30, 2026

(54) Methods, Systems, and Devices for Preparing a Biological Testing Sample

(71) Applicant: IDEXX Laboratories, Inc., Westbrook, ME (US)

(72) Inventors: David Connolly, Eliot, ME (US); Richard Andrews, Gorham, ME (US); Jui Ming Lin, Falmouth, ME (US); Michael Moon, Scarborough, ME (US); Michael Stone, Flamouth, ME (US)

(73) Assignee: IDEXX Laboratories, Inc., Westbrook, ME (US)

(21) Appl. No.: 19/427,633

(22) Filed: Dec. 19, 2025

Related U.S. Application Data
(63) Continuation-in-part of application No. 18/937,097, filed on Nov. 5, 2024.
(60) Provisional application No. 63/604,544, filed on Nov. 30, 2023.

(51) Int. Cl. B01L 3/00

(52) U.S. Cl. CPC B01L 3/508; B01L 2200/0689; B01L 2200/16; B01L 2300/042; B01L 2300/047; B01L 2300/06; B01L 2300/0832

(57) ABSTRACT

A device for preparing a biological testing sample. The device includes a diluent container including: (i) a diluent chamber comprising a liquid diluent and configured to receive a biological sample; (ii) a receiving portion in fluid communication with the diluent chamber; and (iii) a first sealant surface proximate to the receiving portion. The device additionally includes: (i) a cap including (i) a reagent chamber comprising a reagent; (ii) a dispensing nozzle in fluid communication with the reagent chamber, and including a break-away tab covering an opening of the dispensing nozzle; (iii) an insertion portion in fluid communication with the reagent chamber, and configured to interface with the receiving portion of the diluent chamber; and (iv) a second sealant surface, proximate to the insertion portion, wherein the first sealant surface and the second sealant surface form a liquid seal.

### CROSS REFERENCE TO RELATED APPLICATIONS

This application is a continuation-in-part of co-pending U.S. patent application Ser. No. 18/937,097 filed Nov. 5, 2024, which claims the benefit of U.S. Provisional Patent Application Ser. No. 63/604,544, filed Nov. 30, 2023, both of which are hereby incorporated by reference in their entirety.

### FIELD OF THE DISCLOSURE

The present disclosure involves devices, systems, and methods for preparing a biological testing sample. Namely, devices, systems, and methods of the present disclosure involve a diluent container and a cap which can be coupled to one another to prepare a biological sample for testing.

### BACKGROUND

Preparing a biological sample for testing involves mixing the biological sample into a liquid diluent and introducing a reagent to the mixture of the biological sample and the liquid diluent. The combination of the biological sample, the liquid diluent, and the reagent can then be deposited onto a testing surface for evaluation.

### SUMMARY

In an example, a device for preparing a biological testing sample is described. The example device comprises a diluent container and a cap. The example diluent container comprises: (i) a diluent chamber comprising a liquid diluent, wherein the diluent chamber is configured to receive a biological sample; (ii) a receiving portion, wherein the receiving portion is in fluid communication with the diluent chamber; and (iii) a first sealant surface, wherein the first sealant surface is proximate to the receiving portion. The example cap comprises: (i) a reagent chamber comprising a reagent; (ii) a dispensing nozzle, wherein the dispensing nozzle is in fluid communication with the reagent chamber, and wherein the dispensing nozzle comprises a break-away tab covering an opening of the dispensing nozzle; (iii) an insertion portion, wherein the insertion portion is in fluid communication with the reagent chamber, and wherein the insertion portion is configured to interface with the receiving portion of the diluent chamber; and (iv) a second sealant surface, wherein the second sealant surface is proximate to the insertion portion, and wherein the first sealant surface and the second sealant surface form a liquid seal when the insertion portion is interfaced with the receiving portion of the diluent chamber.

In another example, a method for preparing a biological testing sample is disclosed. In an example, the method comprises: (i) depositing a liquid diluent into a diluent chamber of a diluent container; (ii) depositing a reagent into a reagent chamber of a cap; (iii) receiving a biological sample in the diluent chamber of the diluent container; (iv) inserting an insertion portion of the cap into a receiving portion of the diluent container, wherein the receiving portion comprises a first sealant surface that interfaces with a second sealant surface of the insertion portion, and wherein the first sealant surface and the second sealant surface form a liquid seal when interfaced, and wherein the diluent chamber is in fluid communication with the reagent chamber when the insertion portion of the cap is inserted into the receiving portion of the diluent container; and (v) after inserting the insertion portion of the cap into the receiving portion of the diluent container, agitating the reagent with the liquid diluent and the biological sample.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1A illustrates a section view of an example diluent container, according to one or more embodiments shown and described herein.

FIG. 1B illustrates a perspective view of the diluent container of FIG. 1A, according to one or more embodiments shown and described herein.

FIG. 2A illustrates a viewing area of a slide or cartridge including a biological sample comprising constituents, according to one or more embodiments shown and described herein.

FIG. 2B illustrates a viewing area of a slide or cartridge including a biological sample comprising diluted constituents, according to one or more embodiments shown and described herein.

FIG. 2C illustrates a viewing area of a slide or cartridge including a biological sample comprising further diluted constituents, according to one or more embodiments shown and described herein.

FIG. 3A illustrates a section view of a diluent container, according to one or more embodiments shown and described herein.

FIG. 3B illustrates a top section view of the diluent container of FIG. 3A, according to one or more embodiments shown and described herein.

FIG. 4A illustrates a section view of a diluent container, according to one or more embodiments shown and described herein.

FIG. 4B illustrates a top section view of the diluent container of FIG. 4A, according to one or more embodiments shown and described herein.

FIG. 5 illustrates a cap of a diluent container, according to one or more embodiments shown and described herein.

FIG. 6 illustrates a front view of the cap of FIG. 5, according to one or more embodiments shown and described herein.

FIG. 7 illustrates a section view of a cap, according to one or more embodiments shown and described herein.

FIG. 8 illustrates a section view of an assembled device for preparing a biological testing sample according to one or more of the components of FIG. 1A-FIG. 7, according to one or more embodiments shown and described herein.

FIG. 9 illustrates a section view of an assembled device for preparing a biological testing sample according to one or more of the components of FIG. 1A-FIG. 7, according to one or more embodiments shown and described herein.

FIG. 10 illustrates a method, according to one or more embodiments shown and described herein.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

Within examples, the present disclosure is directed to devices, systems, and methods for preparing a biological sample for testing.

Testing and/or analyzing, as referred to herein, may include, for example and without limitation capturing one or more images related to a sample. Testing can involve capturing images of a biological sample with an imaging sensor and determining one or more characteristics of the biological sample. In some embodiments, testing can include determining a stain intensity. In examples, testing can involve modifying an intensity of a light source, then capturing one or more additional images with the imaging sensor. One or more machine learning models can then be implemented to analyze the captured images and perform one or more computational actions, including identifying one or more characteristics of the biological sample.

In some examples, the images are of one or more assays being performed. In some examples, the images are of competitive immunoassays for detection of an analyte in the biological sample. Without being bound by theory, in a competitive immunoassay, a sample, e.g., from an animal's body fluid is examined for the presence of a specific analyte. The sample is combined with a solution including the specific analyte of interest conjugated to a detectable label. The analyte of interest, if present in the sample, competes with the analyte conjugated to the detectable label for binding with one or more target sites including an antibody or antigen that corresponds with the analyte of interest. In particular, in instances in which the analyte of interest is an antibody, the target sites will include an antigen associated with the antibody. By contrast, in instances in which the analyte of interest is an antigen, the target sites will include an antibody associated with the antigen. The amount of the detectable label bound to the targets is related to the amount of analyte of interest present in the sample. More particularly, the amount of detectable label bound to the one or more target sites is inversely related to the amount of analyte of interest present in the sample.

Antibodies, antigens, and other binding members (e.g., aptamers or the like) may be attached to the particle or to the label directly via covalent binding with or without a linker or may be attached through a separate pair of binding members as is well known (e.g., biotin:streptavidin, digoxigenin:anti-digoxiginen). In addition, while the examples herein reflect the use of immunoassays, the particles and methods of the disclosure may be used in other receptor binding assays or any other suitable assay, including and without limitation nucleic acid hybridization assays, that rely on immobilization of one or more assay components to a solid phase.

In some embodiments, the images are utilized for a morphological study of constituents of a biological sample. For example, in some instances, morphology of constituents within the images are evaluated to classify the constituents. In examples in which the sample is blood, blood cell types can be determined based on the constituent's shape. Likewise, in examples in which the sample is a fine needle aspirate (FNA), the cell types of the sample can be determined via morphological study.

Whether for an assay or for a morphological study or any combination of suitable tests, preparing a biological sample for testing involves mixing the biological sample into a liquid diluent. One or more stains and/or one or more reagents are introduced to the mixture of the biological sample and the liquid diluent prior to imaging, testing, and/or performance of other analytical methods. The combination of the biological sample, the liquid diluent, and the reagent can be used to form a biological testing sample, which can then be deposited onto a testing surface (e.g., a slide or cartridge) for testing, such as imaging.

To date, such devices and methods for preparing a biological testing sample require significant manual user handling. Historically, preparation of a biological sample for testing involves a user (e.g., a clinician) manually measuring and handling the liquid diluent to be mixed with the biological sample. Similarly, the preparation may involve the user manually handling and measuring a liquid reagent to agitate and mix with the liquid diluent and biological sample. This process can be time intensive, result in user error in measurement and handling, and produce waste from these potential user errors.

The example systems, devices, and methods disclosed herein address these issues related to prior sample preparation. An example device of the present disclosure is configured to receive a biological sample and mix the biological sample with liquid diluent. In some embodiments, a reagent and/or stain is introduced to the mixture, and the mixture of biological sample, diluent, and/or reagent or stain is dispensed onto a testing surface. More particularly, an example device includes a diluent container, which houses a liquid diluent and is configured to receive a biological sample. The device also includes cap configured to be coupled to the diluent container. The cap, in some embodiments, is a reagent container, which houses a reagent and is configured to be coupled to the diluent container. Once the biological sample is deposited into the diluent container, the diluent container and the cap can be connected and/or otherwise interfaced. In embodiments in which the cap includes reagent, the reagent is introduced to the mixture of the liquid diluent and the biological sample. In examples, the cap includes features to allow for use of lyophilized reagent. In examples, the cap includes a dispensing nozzle for dispensing the biological testing sample (e.g., the mixture of the liquid diluent, the biological sample, and the reagent) onto a testing surface.

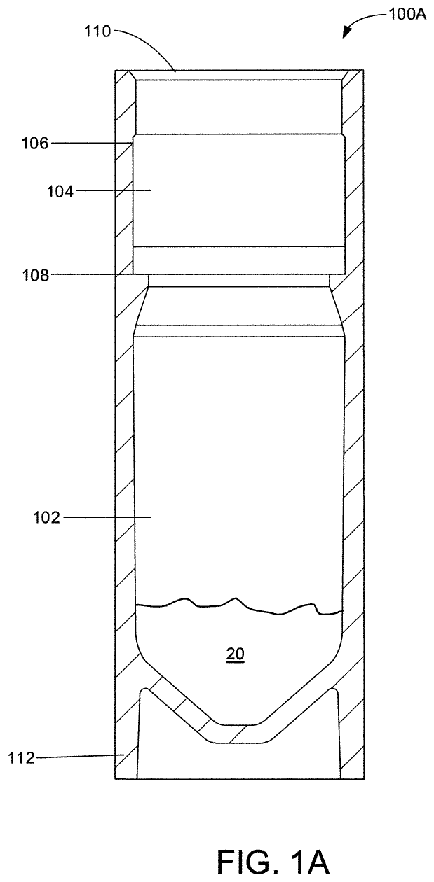

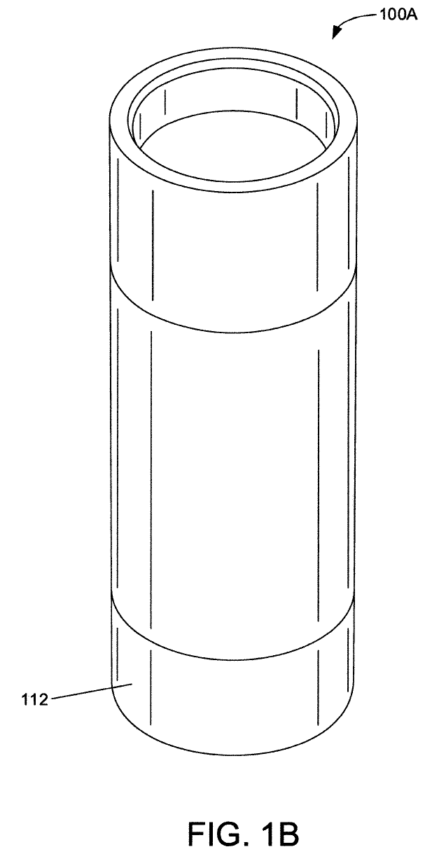

Now referring to the figures, FIGS. 1A and 1B illustrate a diluent container 100A, according to an example embodiment. The diluent container 100A holds a liquid diluent 20 and is configured to receive the biological sample. As shown in FIG. 1A, the diluent container 100A includes a diluent chamber 102, a receiving portion 104 in fluid communication with the diluent chamber 102, and a first engagement surface 106, proximate to the receiving portion 104. In example embodiments, the diluent container 100A includes a sealant member110 covering an opening of the receiving portion 104.

In example embodiments, the diluent chamber 102 houses the liquid diluent 20. Some example liquid diluents include, but are not limited to Phosphate-Buffered Saline (PBS), Tris-Buffered Saline (TBS), water, saline solution, and glycerol-based buffer solution. Other example diluents are possible.

According to an example embodiment, having an appropriate volume of liquid diluent in the diluent chamber 102 eliminates the need for a user to manually measure and prepare the liquid diluent. This configuration may improve testing time and eliminate any potential user error in measurement and/or preparation. Reducing manual user handling of the liquid diluent may additionally reduce the risk of contaminating the liquid diluent and/or the diluent chamber 102.

In embodiments, the diluent chamber 102 is configured to hold a sufficient amount of liquid diluent to prepare the biological testing sample, while still allowing space for a biological testing sample. For instance, in some example embodiments, the diluent chamber 102 may include between about 250 μL and about 2 mL of liquid diluent 20, inclusive of the endpoints. In some embodiments, the diluent chamber 102 includes between about 200 μL and about 3 mL of liquid diluent 20, inclusive of the endpoints. In embodiments, the volume of diluent is associated with the intended use of the diluent container 100A (e.g., type of biological sample being tested, type of testing performed, etc.).

In some embodiments, the diluent chamber 102 includes about 250 μL of liquid diluent 20. In some embodiments, the diluent chamber 102 includes between about 230 μL and about 280 μL of liquid diluent 20, inclusive of the endpoints.

In some embodiments, the diluent is utilized to prepare a FNA sample. FNA sample interrogation is useful in many situations, for example, in the examination of lesions, tumors, and the like, sometimes referred to as “lumps and bumps” by medical professionals. Lesions and tumors, such as those found in humans and non-human animals such as dogs and cats, commonly lack uniform distribution of fluid within the lesion. Moreover, in many instances limited fluid can be drawn from the tumor or lesion.

Non-uniformity and limited fluid within the lesions and tumors can lead to limited and non-uniformly distributed cells within the drawn fluid sample. Because FNA samples have limited and/or non-uniformly distributed cells within the sample, interrogation of un-diluted FNA samples is challenging.

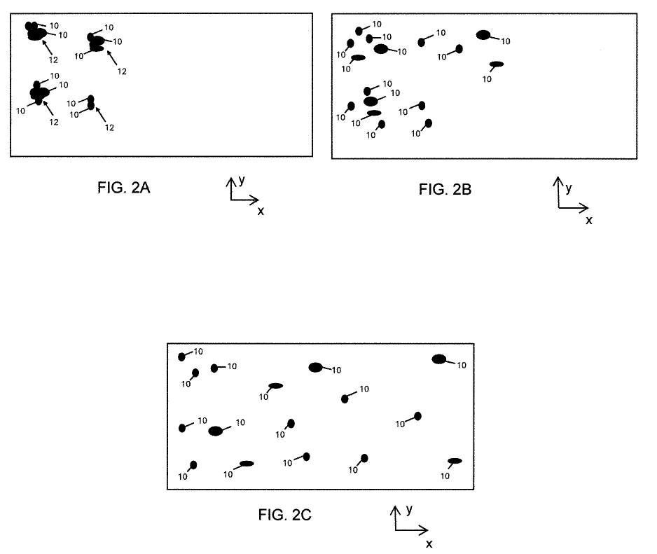

For example and referring to FIG. 2A, a viewing area of a slide or cartridge is depicted. As shown in FIG. 2A and without being bound by theory, constituents 10 in an un-diluted sample may present in clumps 12. Morphological interrogation of individual constituents 10 in the clumps 12 is difficult. In particular, the features of individual constituents 10 within the clumps 12 are difficult to distinguish from one another, frustrating the ability to identify characteristics of the individual constituents 10.

By contrast and referring to FIG. 2B, a diluted sample positioned in a viewing area of a slide or cartridge is depicted. By diluting FNA samples with a diluent, the constituents 10 of the sample are generally separated from one another and distributed across the cartridge or slide, allowing for faster and more accurate interrogation of the characteristics of individual constituents 10.

Without being bound by theory, it is desirable to use as little diluent as practicable to distinguish individual constituents 10 from the clumps 12 (FIG. 2A). For example and referring to FIG. 2C, a viewing area of a slide or cartridge with excess diluent is depicted. As depicted, excess diluent can separate the constituents 10 across the slide or cartridge. Because the constituents 10 are spread across the slide or cartridge, evaluation of the constituents 10 can be time-consuming as compared to instances in which the constituents 10 are closer together as shown in FIG. 2B. More particularly, in many instances, the field-of-view of a microscope is smaller than the viewable area of the slide or cartridge. Accordingly, with the constituents 10 spread across the slide or cartridge, all or most of the slide or cartridge (e.g., in the x-direction and y-direction as depicted) may need to be imaged to capture images of all or most of the constituents 10. In instances in which a cartridge is used, all or most of the slide or cartridge might also need to be imaged in a depth direction (e.g., in a direction transverse to the x-direction and y-direction as depicted).

However, if less diluent is utilized, as shown in FIG. 2B, most or all of the constituents 10 are positioned in a portion of the viewing area of the slide or cartridge. Accordingly, the sample may be effectively evaluated without analyzing each portion of the viewing area of the slide or cartridge in detail.

However, the shelf-life of diluent generally corresponds to the volume of diluent being stored. In particular and without being bound by theory, the greater volume of diluent being stored in a container, the less susceptible the stored diluent is to degradation, evaporation, and the like. Accordingly, selection of a volume of diluent 20 in the diluent chamber 102 for FNA testing requires balancing the competing need to minimize diluent, while providing diluent volume sufficient to achieve an acceptable shelf-life. Embodiments according to the present disclosure for use with FNA sample testing include about 250 μL of liquid diluent 20. Diluent volumes of about 250 μL allows the diluent to effectively prepare samples for imaging while maintaining an acceptable shelf-life.

Returning to FIG. 1A, after the liquid diluent is deposited into the diluent chamber 102, the diluent container 100A can be sealed by way of the sealant member 110. In embodiments, the sealant member 110 creates a liquid and/or airtight seal, sealing the diluent 20 in the diluent chamber 102. By creating the liquid and/or airtight seal, the sealant member 110 preserves the diluent 20 within the container 100A during transportation, storage, and handling. In examples, the sealant member 110 can adhere to a perimeter of an opening of the receiving portion 104. In some example embodiments, the sealant member 110 can include foil. Additionally, or alternatively, the sealant member 110 can include plastics. Other example materials and configurations are possible. In practice, according to example embodiments, the sealant member 110 may remain intact until the diluent container 100A is ready for use.

When the diluent container 100A is ready for use, the sealant member 110 can be removed to expose the receiving portion 104 and the diluent chamber 102. In some example embodiments, the sealant member 110 is configured to be removed by a user (e.g., a clinician). In some examples, the sealant member 110 is configured to be removed by way of peeling or puncturing. For instance, in some examples, the sealant member 110 can include a pull tab and/or perforations for ease of removal. Other examples removal methods are possible.

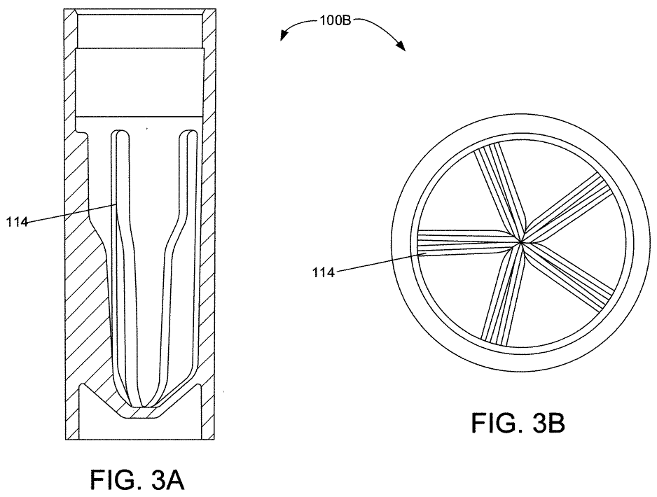

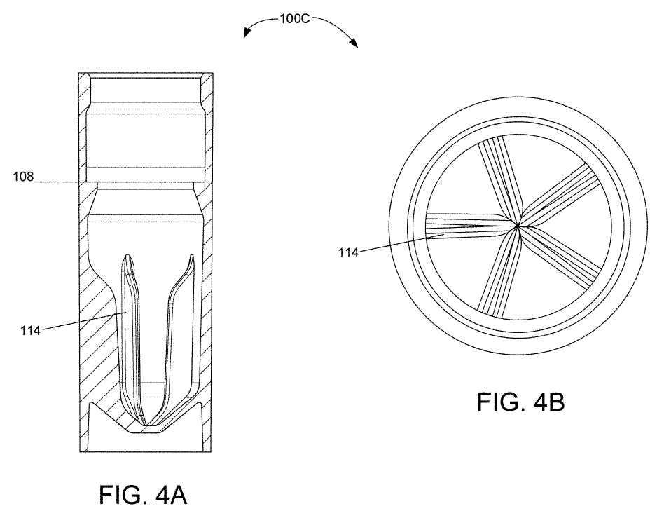

In embodiments, the sealing member 110 can be removed and biological sample deposited in the diluent container 100A. In some embodiments, the biological sample can be deposited in the diluent container 100A with the sealing member 110 coupled to the diluent container 100A, for example by puncturing the sealing member 110 with a syringe containing the biological sample. In examples, the biological sample can be deposited into the diluent chamber 102 to be mixed with the liquid diluent. In some examples, the biological sample is a liquid biological sample such as: (i) blood; (ii) urine; (iii) saliva; (iv) fecal matter; (v) secretion; (vi) excretion; (vii) Fine Needle Aspirate (FNA); (viii) lavage fluids; (ix) body cavity fluids; (x) semen; and (xi) bacteria. In example embodiments, these liquid biological samples may be collected and deposited into the diluent chamber 102 by way of a syringe, for example. In additional examples, the biological sample is a solid biological sample, such as: (i) ear wax; (ii) skin cells; (iii) fecal matter; and (iv) biopsied samples. In example embodiments, as further detailed in connection with FIGS. 3A-4B, these solid biological samples may be collected and deposited into the diluent chamber via an applicator (e.g., a cotton swab).

In examples where the biological sample is a liquid biological sample, the diluent chamber 102 and receiving portion 104 may be large enough to allow a user to insert a syringe to the bottom of the diluent chamber 102 and dispense the biological sample into the liquid diluent without overflow or spillage of the biological sample and/or the liquid diluent. For example, in some embodiments, the liquid diluent 20 has a depth of about 0.25 inches. In some embodiments, the diluent chamber 102 has a shape and size, e.g., a conical shape or the like and/or a predetermined span/diameter, to achieve a depth of about 0.25 inches of liquid diluent 20. In examples, FNA syringe needles have predetermined lengths, and about 0.25 inches of liquid diluent is sufficient to allow insertion of the FNA sample into the liquid diluent without overflow or spillage.

Similarly, in examples where the biological sample is a solid biological sample, the diluent chamber 102 and receiving portion 104 are large enough to allow a user to insert an applicator to the bottom of the diluent chamber 102 and deposit the biological sample into the liquid diluent without overflow or spillage of the biological sample and/or the liquid diluent.

In examples, the diluent container 100A is made of a compliant material so that the user can compress (e.g., pinch or squeeze) the diluent container 100A. This is beneficial for depositing a biological sample, such as ear wax, into the diluent container 100A as the user can utilize the friction between the side walls to extract the sample from an application. Additionally, this is beneficial for depositing the biological testing sample (e.g., onto a cartridge) for testing. As such, in some example embodiments, the diluent container 100A includes compliant material, such as Linear Low Density Polyethylene (LLDPE) or Low Density Polyethylene (LDPE). Other example materials are possible.

In some example embodiments, the diluent container 100A includes a base 112 to stabilize diluent container 100A and allow the diluent container 100A to stand vertically without additional support. For instance, the base 112 may include a ring around an outer perimeter of the diluent container 100A. This allows a user to more easily dispense or deposit the biological sample into the diluent chamber 102. Further, the base 112 can help prevent spillage of the liquid diluent and/or the biological sample.

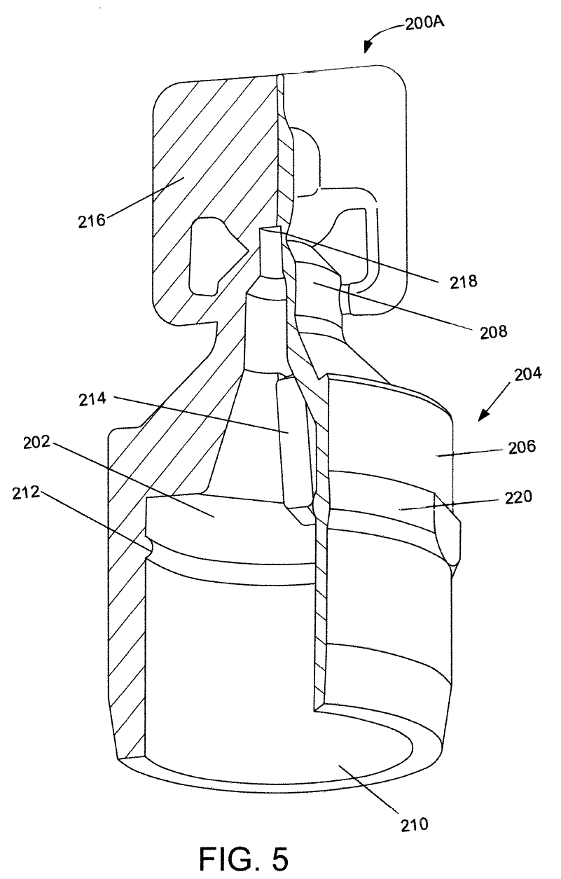

After the biological sample is deposited into the diluent chamber 102 and the liquid diluent, the diluent container 100A may then be ready to receive a cap (e.g., 200A or 200B as shown in FIGS. 5-7). More particularly, the receiving portion 104 of the diluent container 100A is configured to be coupled to the cap. The receiving portion 104 includes a first sealant surface 106 that, when interfaced with a second sealant surface of the cap (shown in FIGS. 5-7), creates a liquid seal between the diluent container 100A and the cap.

To facilitate receiving the cap, in some examples, the receiving portion 104 includes a support shoulder 108. The support shoulder 108 supports and stabilizes the cap (as shown in FIGS. 5-7), when a portion of the cap is inserted into the receiving portion 104 of the diluent container 100A. More particularly, when the cap is inserted into the receiving portion 104 of the diluent container 100A, the bottom of the cap is supported by the support shoulder 108. This helps stabilize the cap to remain in position and prevents the cap from being inserted too far into the diluent container 100A.

Now referring to FIGS. 3A and 3B, vertical and horizontal cross-sectional views of a diluent container 100B are illustrated according to an example embodiment. In FIGS. 3A and 3B, the diluent container 100B includes largely the same features as the diluent container 100A, shown in FIGS. 1A-1B and described in the corresponding description. As shown in FIGS. 3A and 3B, however, the diluent container 100B includes extraction ribs 114 in the diluent chamber 102. The extraction ribs 114 aid in extracting the biological sample and supporting the cap, as described in further detail below.

As shown in the example configuration in FIGS. 3A and 3B (a top down view of FIG. 3A), in example embodiments, the extraction ribs 114 can extend vertically from the base of the diluent chamber 102. Additionally, in examples, the extraction ribs 114 can include 5 extraction ribs 114 extending radially from one another. Many example configurations of extraction ribs are possible. For instance, in some examples, the diluent container 100B can include fewer extraction ribs 114 (e.g., 2, 3, or 4). In other examples, the diluent container 100B can include more extraction ribs 114 (e.g., 6, 7, 8, etc.). Additionally or alternatively, in example embodiments extraction ribs may extend radially inward from the side walls of the diluent chamber 102, rather than vertically from the base of the diluent chamber 102.

As noted above, in practice, some biological samples (e.g., ear wax) are collected via an applicator, such as a cotton swab. Removal of the biological sample from the applicator can be challenging because the biological sample may stick to the applicator. To better facilitate removal of the biological sample from the applicator, the user can place the applicator into the diluent chamber 102, making contact with the extraction ribs 114. The user can then press the applicator against the extraction ribs 114 to scrape the biological sample from the applicator. Additionally or alternatively, the user can spin the applicator when inserted into the diluent chamber 102 to remove the biological sample from the applicator. Further, as noted above, the diluent container 100B is compliant such that the user can pinch or squeeze the diluent container 100B. As such, the user can also pinch the diluent container 100B, creating or increasing friction between the applicator and the extraction ribs 114 to remove the biological sample from the applicator and into the diluent chamber 102.

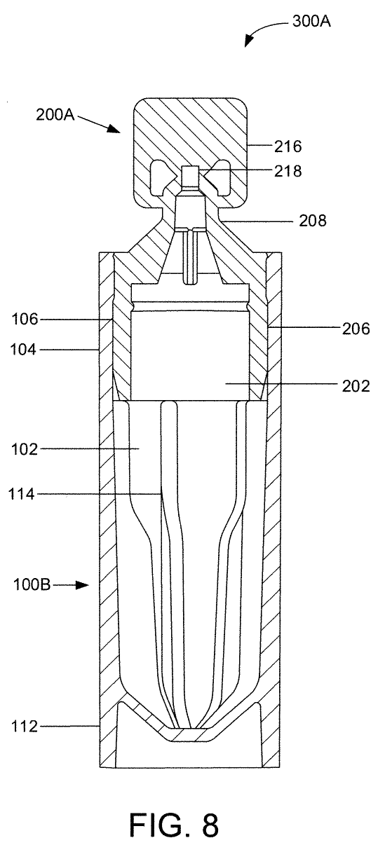

Additionally, the extraction ribs 114 aid in supporting and stabilizing the cap (as shown in FIGS. 5-7), when a portion of the cap is inserted into the receiving portion 104 of the diluent container 100B. More particularly, when the cap is inserted into the insertion portion 104 of the diluent container 100B, the bottom of the cap is supported by the top of extraction ribs 114. This holds the cap in a proper position and prevents the cap from being inserted too far into the diluent container 100B. This configuration is shown in FIG. 8 and further described in the associated section.

Now referring to FIGS. 4A and 4B, vertical and horizontal cross-sectional views of a diluent container 100C are illustrated according to an example embodiment. In FIGS. 4A and 4B, the diluent container 100C includes largely the same features as the diluent containers 100A and 100B, shown in FIGS. 1A-3B and described in the corresponding description. As shown in FIGS. 4A and 4B, the diluent container 100C includes a support shoulder 108 and extraction ribs 114 in the diluent chamber 102. In the example shown in FIGS. 4A and 4B, the extraction ribs 114 may be shorter in some examples (e.g., as compared to the extraction ribs 114 shown in FIG. 3A).

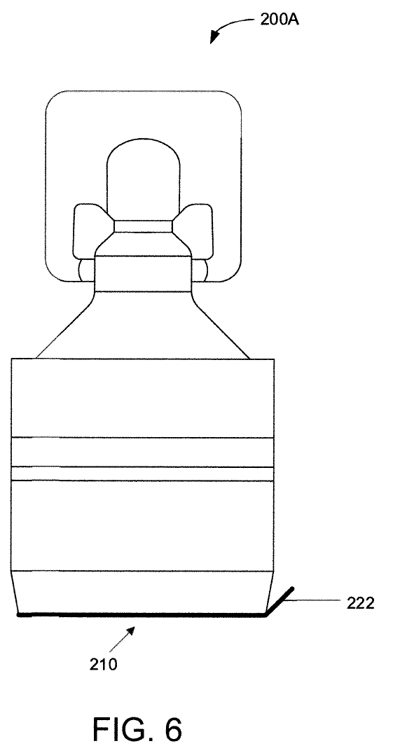

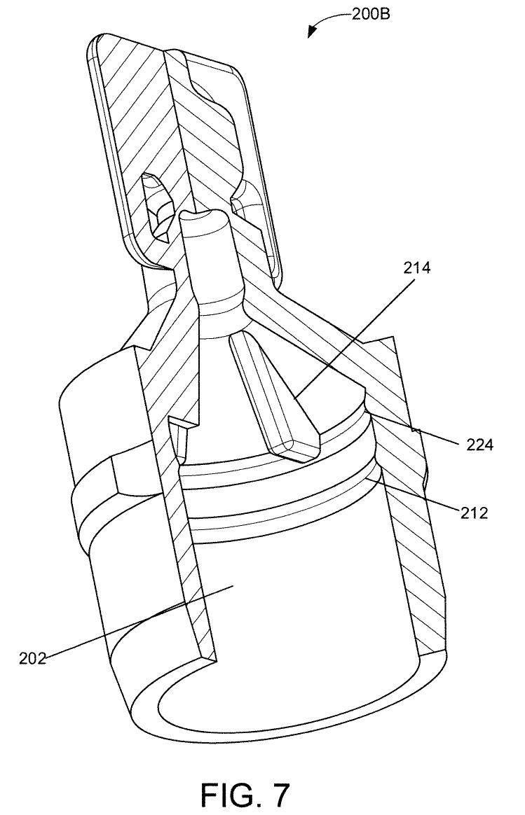

Now referring to FIGS. 5 and 6, an example cap 200A is disclosed. In examples, a cap 200A includes a reagent chamber 202 to hold the reagent, an insertion portion 204 (e.g., to be inserted in the receiving portion 104 of the diluent chamber 102), and a second sealant surface 206 to interface with the first sealant surface 106 of the diluent chamber 102. Additionally, in example embodiments, the cap 200A includes a dispensing nozzle 208 to dispense the biological testing sample, once prepared, onto a testing surface, such as a slide or cartridge. In examples, the cap 200A may additionally include a sealant member covering an opening 210 of the reagent chamber 202, to preserve the reagent and reagent chamber 202.

As noted above, in examples, the reagent chamber 202 contains one or more reagents. In some examples, the reagent is a liquid reagent. In some examples, the liquid reagent includes quality control beads. Additionally or alternatively, in some examples, the liquid reagent includes one or more fluorescent stains. During fabrication, the liquid reagent can be deposited into the reagent chamber 202 via the opening 210 of the reagent chamber 202. In some examples, the reagent chamber 202 is then sealed via the sealant member 222 for transportation, storage, and/or handling.

Additionally or alternatively, in some examples, the reagent is a solid reagent. As noted above, lyophilized reagents are beneficial for particular types of testing. For instance, a lyophilized reagent may be more uniform than a liquid reagent. Uniformity of the reagent can result in one or more improvements to associated testing protocols, including better imaging and more accurate test results. Further, lyophilization of the reagent can help with preservation of the reagent so that it does not deteriorate over time or become contaminated. Moreover, lyophilized reagents can be stored at room temperature, whereas liquid reagents typically have to be refrigerated. As such, lyophilized reagents may have a longer shelf life and be easier to store than liquid reagents. Even further, the lyophilized reagent can be provided in predetermined quantities (e.g., tablets of known volume), and as such do not require a user measurement and require less user handling, which in turn can reduce testing time, increase repeatability and consistency among tests, and help ensure the right quantity of reagent is used.

In some example embodiments, during fabrication, the reagent is deposited into the reagent chamber 202 then lyophilized to form a solid lyophilized reagent. For instance, in some examples, the lyophilized reagent may include quality control beads. Additionally or alternatively, the lyophilized reagent may include one or more fluorescent stains. Once, the reagent is lyophilized, the reagent chamber 202 can then be sealed via the sealant member for transportation, storage, and/or handling.

In example embodiments, the reagent chamber 202 includes one or more reagent retention mechanisms to help prevent the lyophilized reagent from dislodging during fabrication, transportation, storage, and/or handling. For instance, in some example embodiments, the reagent chamber 202 includes a ring portion 212 on the inside of the reagent chamber 202 to act as a reagent retention mechanism. During lyophilization, the reagent can solidify around the surface of the ring portion 212. This prevents the lyophilized reagent from moving or dislodging from the reagent chamber 202. For example, the ring portion 212 helps prevent dislodging when the sealant member is removed from the opening 210 of the cap 200A. Further, the ring portion 212 increases the surface area of the lyophilized reagent, thereby increasing the surface tension between the lyophilized reagent and the reagent chamber 202. In examples, the increase in surface tension may further prevent the lyophilized reagent from dislodging from the reagent chamber 202 during manufacturing, transportation, storage, and/or handling. Further, in some examples, the reagent chamber 202 includes one or more fins 214 on the inside of the reagent chamber 202 to act as a reagent retention mechanism. During lyophilization, the reagent can solidify on the surface of the fins 214, preventing torsional movement and/or rotation during fabrication, transportation, storage, and/or handling. For example, the fins 214 helps prevent the lyophilized reagent from shifting or dislodging when the sealant member is removed from the opening 210 of the cap 200A. Further, the fins 214 increase the surface area of the lyophilized reagent, thereby increasing the surface tension between the lyophilized reagent and the reagent chamber 202. The increase in surface tension further prevents the lyophilized reagent from dislodging from the reagent chamber 202 during fabrication, transportation, storage, and/or handling.

As noted above, during fabrication, in example embodiments, after the reagent (whether liquid or solid) is deposited and/or prepared in the reagent chamber 202, the reagent chamber 202 is then sealed via the sealant member 222 for transportation, storage, and/or handling. The sealant member 222, shown in FIG. 7, creates a liquid and/or airtight seal to help preserve the reagent and reagent chamber 202. Further, the sealant member 222 can prevent contamination, deterioration, and/or aging of the reagent. In examples, the sealant member 222 can adhere to the perimeter of the opening 210 of the reagent chamber 202. In some example embodiments, the sealant member 222 includes foil. Additionally or alternatively, the sealant member 222 can include plastics. Other example materials and configurations are possible.

Once the biological testing sample is prepared, the sealant member 222 can be removed or punctured such that the reagent is exposed via the opening 210. In some example embodiments, the sealant member 222 is configured to be removed by a user (e.g., a clinician), for example by way of peeling or puncturing. For instance, in some examples, the sealant member can include a pull tab and/or perforations for ease of removal. Additionally or alternatively, in some examples the diluent container 100A, 100B, or 100C can include a puncturing mechanism to puncture the sealant member. Other examples are possible.

Once the sealant member 222 is removed or punctured, the insertion portion 204 of the cap 200A can be inserted into the receiving portion 104 of the diluent container 100A, 100B, or 100C (as shown in FIG. 8). When the diluent container 100A, 100B, or 100C and cap 200A are coupled in this manner, the first sealant surface 106 and the second sealant surface 206 create a liquid seal between the diluent container 100A, 100B, or 100C and the cap 200A. The liquid seal prevents spillage or leakage of the liquid diluent, the biological sample, and/or the reagent.

In some examples, the second sealant surface 206 includes a sealant ring 220 configured to interface with the first sealant surface 106 of the diluent container 100A, 100B, or 100C. In example embodiments, the sealant ring 220 includes one or more flat portions. The one or more flat portions aid in venting the diluent container 100A, 100B, or 100C as the cap 200 is inserted into the diluent container 100 to prevent the diluent chamber 102 from pressurizing. If the diluent chamber is pressurized, fluid (e.g., the biological testing sample) could eject from the opening 218 when the opening 218 is exposed (e.g., when a break-away tab 216 is removed).

Additionally, once the insertion portion 204 of the cap 200A is inserted into the receiving portion 104 of the diluent container 100A, 100B, or 100C, the diluent chamber 102 is in fluid communication with the reagent chamber 202 (as shown in FIG. 8). As such, the diluent container 100A, 100B, or 100C and cap 200A or 200B can be specifically handled, inverted, and/or shaken, to agitate the reagent and mix it with the liquid diluent and the biological sample to form the biological testing sample. In examples where the reagent is a solid lyophilized reagent, agitation of the reagent with the liquid diluent can liquefy the reagent. This allows the reagent, liquid diluent, and biological sample to mix and prepare the biological testing sample for dispensing and testing.

Once the biological testing sample is prepared, the biological testing sample can be dispensed onto a testing surface (e.g., a slide or a cartridge) by way of the dispensing nozzle 208. The dispensing nozzle 208 is in fluid communication with the reagent chamber 202 and includes an opening 218, the opening 218 being sealed until the biological testing sample is prepared. In examples, the opening 218 is covered by the break-away tab 216. In examples, the break-away tab 216 includes perforations for ease of removal. For instance, the user can apply force to twist or bend the break-away tab 216 to remove it from the dispensing nozzle 208 and expose the opening 218.

In examples, when the break-away tab 216 is removed and the opening 218 of the dispensing nozzle 208 is exposed, the biological testing sample can be dispensed, for example, onto a testing surface, such as a slide or cartridge. In examples, the opening 218 of the dispensing nozzle 208 is configured to dispense the biological testing sample at a particular flow rate. For example, the opening of the dispensing nozzle 208 may be configured to effectuate a particular flow rate for a particular liquid, such as a biological testing sample that is to be deposited onto a testing surface (e.g., a slide or cartridge) for testing, such as imaging. More particularly, the opening 218 has a particular cross-sectional area to achieve a desired flow rate of the biological sample. Dispensing the biological testing sample onto a testing surface, such as a slide or cartridge, at a particular flow rate can help control the placement of the biological testing sample onto the testing surface and prevent splatter.

Turning to FIG. 6 the example cap 200A of FIG. 5 is disclosed, with the sealant member 222 covering opening 210 of the reagent chamber, to preserve the one or more reagents in the reagent chamber. As shown in FIG. 5, the sealant member 222 includes a pull tab and may be made of one or more of the materials described above (e.g., foil, plastic, etc.). Other examples are possible.

Now referring to FIG. 7, another example of a cap 200B, according to an example embodiment. In FIG. 7, the cap 200B includes largely the same features as the cap 200A, shown in FIG. 5-6 and described in the corresponding description. As shown in FIG. 7, the cap 200B can include an additional ring portion 224 on the inside of the reagent chamber 202 to act as a reagent retention mechanism, in addition to the ring portion 212 and the one or more fins 214. During lyophilization, the reagent can solidify around the surface of the ring portion 224. This prevents the lyophilized reagent from moving or dislodging from the reagent chamber 202. For example, the ring portion 224 helps prevent dislodging when the sealant member is removed from the opening 210 of the cap 200. Further, the ring portion 212 increases the surface area of the lyophilized reagent, thereby increasing the surface tension between the lyophilized reagent and the reagent chamber 202. In examples, the increase in surface tension may further prevent the lyophilized reagent from dislodging from the reagent chamber 202 during manufacturing, transportation, storage, and/or handling.

Moreover, in some examples, during fabrication, the reagent can be deposited into the reagent chamber 202 while the cap 200B is inverted. In other words, the opening 218 is towards the “bottom” of the cap 200B while the reagent is deposited. Accordingly, the reagent fills from at or near the opening 218 towards the reagent chamber 202. In examples where smaller volumes of reagent are utilized, the reagent may not reach the ring portion 212. Ring portion 224 can be positioned closer to the opening 218 than ring portion 218 (i.e., between opening 218 and ring portion 218) so that, in examples where the reagent does not reach the ring portion 212, the ring portion 224 can act as a reagent retention mechanism.

Now referring to FIG. 8, a device 300A for preparing a biological sample, according to an example embodiment. The device 300A includes the diluent container 100B of FIGS. 3A and 3B and the cap 200A of FIGS. 5 and 6 coupled to one another. As described above, the diluent container 100B includes a receiving portion 104 configured to receive an insertion portion 204 of the cap 200. The first sealant surface 106 of the receiving portion 104 interfaces with the second sealant surface 206 of the insertion portion 204 to form a liquid seal between the diluent container 100B and the cap 200.

In example embodiments where the diluent container 100B includes extraction ribs 114, as shown in FIG. 8, the extraction ribs 114 can support and stabilize the cap 200. More particularly, the bottom of the cap 200A is supported by the extraction ribs 114. This holds the cap in a proper position and prevents the cap 200A from being inserted too far into the diluent container 100B.

As shown in FIG. 8, the diluent chamber 102 is in fluid communication with the reagent chamber 202, allowing the reagent to mix with the liquid diluent and the biological sample. The device 300A can be handled, for example, inverted and/or shaken, to agitate the reagent and mix it with the liquid diluent and the biological sample to form the biological testing sample. In examples where the reagent is a solid lyophilized reagent, agitation of the reagent with the liquid diluent can liquefy the reagent. This allows the reagent, liquid diluent, and biological sample to mix and prepare the biological testing sample for dispensing and testing. During such handling, spillage or leakage of the fluids (e.g., the liquid diluent, the biological sample, and the reagent) is prevented by way of the liquid seal created by the interface of the first sealant surface 106 and the second sealant surface 206.

Once the biological testing sample is prepared, the biological testing sample can be dispensed onto a testing surface (e.g., a slide and/or a cartridge) by way of the dispensing nozzle 208. The dispensing nozzle 208 is in fluid communication with the reagent chamber 202 and the diluent chamber 102. In examples, the dispensing nozzle includes an opening 218, the opening 218 being sealed until the biological testing sample is prepared. In examples, the opening 218 is sealed by way of a break-away tab 216. In examples, the break-away tab 216 includes perforations for ease removal. For instance, the user can twist or bend the break-away tab 216 to remove it from the dispensing nozzle 208 and expose the opening 218.

As noted above in reference to FIG. 6, in example embodiments, second sealant surface 206 may include one or more flat portions. The one or more flat portions aid in venting the diluent container 100B as the cap 200A is inserted into the diluent container 100B to prevent the diluent chamber 102 from pressurizing. If the diluent chamber is pressurized, fluid (e.g., the biological testing sample) could eject from the opening 218 when the break-away tab 216 is removed.

When the break-away tab 216 is removed and the opening 218 of the dispensing nozzle 208 is exposed, the biological testing sample can be dispensed from the device 300A onto a testing surface, such as a slide or cartridge. In examples, the opening of the dispensing nozzle 208 is configured to dispense the biological testing sample at a particular flow rate. More particularly, the opening 218 has a particular cross-sectional area to achieve a desired flow rate of the biological sample. Dispensing the biological testing sample onto a testing surface, such as a slide or cartridge, at a particular flow rate can help control the placement of the biological testing sample onto the testing surface and prevent splatter.

Additionally, as noted above, the diluent container 100A, 100B, or 100C is made of a compliant material (e.g., LLDPE and/or LDPE) so that the user can pinch or squeeze the diluent container 100 to dispense the biological testing sample onto the testing surface. In example embodiments, the compliant material is configured to dispense the biological sample at a particular flow rate. This helps further control placement of the biological testing sample onto the testing surface and prevent splatter.

Moreover, the first sealant surface 106 and the second sealant surface 206 are configured to maintain the liquid seal while the diluent container 100B is pinched or squeezed to prevent leakage and/or spillage as the biological testing sample is dispensed.

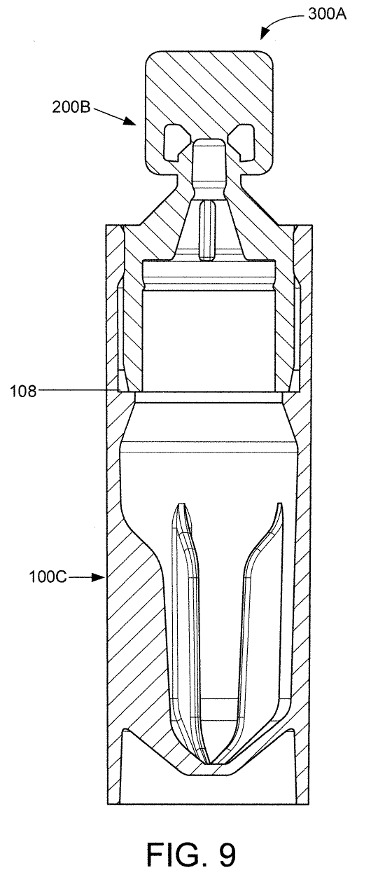

Now referring to FIG. 9, another example of a device 300B for preparing a biological sample, according to an example embodiment. The device 300B includes the diluent container 100C of FIGS. 4A and 4B and the cap 200B of FIG. 7 coupled to one another. In FIG. 9, the example device 300B includes largely the same features as the example device 300A shown in FIG. 8 and described in the corresponding description. However, as shown in FIG. 9, the diluent container 100C includes a support shoulder 108.

While FIG. 8 illustrates the combination of diluent container 100B and cap 200A and FIG. 9 illustrates the combination of diluent container 100C and cap 200B, many example combinations of diluent containers and caps are possible. For instance, diluent container 100A may be coupled to cap 100A or 100B. Further, diluent container 100B may be coupled to cap 200B. And, diluent container 100C can be coupled to cap 200A. Many example implementations are possible.

In some example embodiments, the biological testing sample can be used for a variety of tests. For instance, these tests may include imaging of one or more of the following: (i) blood; (ii) urine; (iii) saliva; (iv) fecal matter; (v) secretion; (vi) excretion; (vii) FNA; (viii) lavage fluids; (ix) body cavity fluids; (x) semen; (xi) ear wax; (xii) skin cells; (xiii) biopsied samples, (xiv) exotics; (xv) cultured cells; (xvi) bacteria; (xvii) worms; (xviii) parasites; and (xix) ear mites, among other possibilities. Test may additionally include one or more of the following: blood coagulation test, polymerase chain reaction (PCR) test, and/or immunoassay, among other possibilities. For example, in some example embodiments, these tests may include one or more of the following blood chemistry tests: SDMA, Total T4 (TT4), Bile Acids, C-reactive Protein (CRP), Progesterone, Fructosamine, and/or Phenobarbital (PHBR), among other possibilities. For example, in some example embodiments, these tests may include one or more of the following blood chemistry profile tests that measure one or more of the following: ALB, ALB/GLOB, ALKP, ALT, AMYL, AST, BUN, BUN/CREA, Ca, CHOL, CK, Cl, CREA, CRP, FRU, GGT, GLOB, GLU, K, LAC, LDH, LIPA, Mg, Na, NH₃, PHOS, TBIL, TP, TRIG and/or URIC, among other possibilities. Other examples are possible.

### Example Methods and Aspects

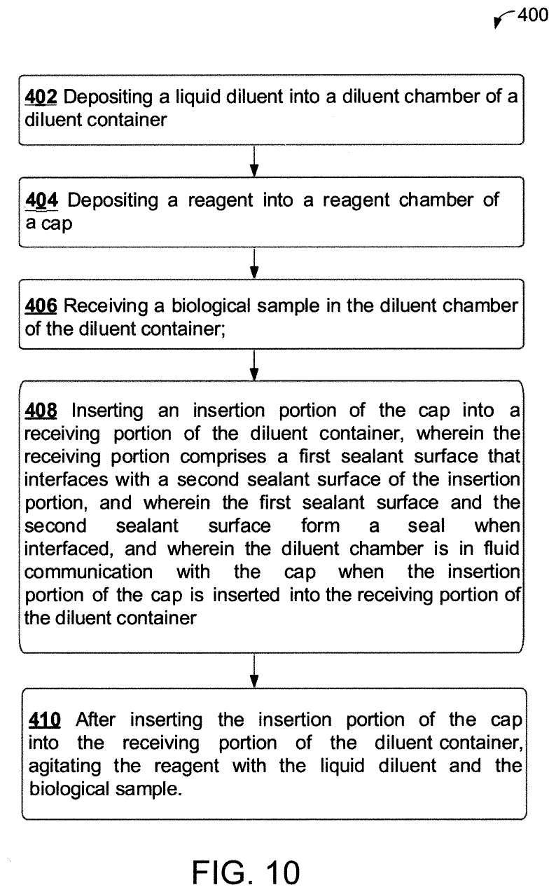

Now referring to FIG. 10, an example method of preparing a biological testing sample is disclosed. Method 400 shown in FIG. 10 presents an example of a method for preparing a biological testing sample that could be used with the components shown in FIGS. 1-9, for example. Further, devices or systems may be used or configured to perform logical functions presented in FIG. 10. In other examples, components of the devices and/or systems may be arranged to be adapted to, capable of, or suited for performing the functions, such as when operated in a specific manner. Method 400 may include one or more operations, functions, or actions as illustrated by one or more of blocks 402-410. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 402, method 400 involves depositing a liquid diluent into a diluent chamber of a diluent container. In some examples, the diluent chamber is in fluid communication with the reagent chamber when the insertion portion of the reagent chamber is interfaced with the receiving portion of the diluent chamber. In some examples, the diluent chamber further comprises one or more chambers configured to receive a liquid biological sample. In some examples, the biological sample comprises a liquid biological sample. In some examples, the liquid biological sample comprises one or more of the following: (i) blood; (ii) urine; (iii) saliva; (iv) fecal matter; (v) secretion; (vi) excretion; (vii) Fine Needle Aspirate (FNA); (viii) lavage fluids; (ix) body cavity fluids; and (x) semen. In some examples, the diluent chamber further comprises one or more extraction ribs configured to extract a biological sample. In some examples, the biological sample comprises ear wax. In examples, the diluent container further comprises a sealant member covering an opening of the receiving portion

At block 404, method 400 involves depositing a reagent into a reagent chamber of a cap. In some examples, block 402 additionally involves lyophilizing the reagent to form a solid reagent. In some examples, the reagent comprises a liquid reagent. In some examples, the reagent comprises a solid reagent. In some examples, the solid reagent comprises a lyophilized reagent. In some examples, the lyophilized reagent comprises one or more quality control beads. In some examples, the lyophilized reagent comprises one or more fluorescent stains. In some embodiments, the reagent chamber further comprises a reagent retention mechanism. In examples, the reagent retention mechanism comprises a ring portion inside the reagent chamber. In some examples, the reagent retention mechanism comprises one or more fins inside the reagent chamber. In some examples, the cap further comprises a sealant member covering an opening of the insertion portion.

At block 406, method 400 involves receiving a biological sample into the diluent chamber of the diluent container.

At block 408, method 400 involves inserting an insertion portion of the cap into a receiving portion of the diluent container, wherein the receiving portion comprises a first sealant surface that interfaces with a second sealant surface of the insertion portion, and wherein the first sealant surface and the second sealant surface form a liquid seal when interfaced, and wherein the diluent chamber is in fluid communication with the reagent chamber when the insertion portion of the cap is inserted into the receiving portion of the diluent container.

At block 410, method 400 involves, after inserting the insertion portion of the cap into the receiving portion of the diluent container, agitating the reagent with the liquid diluent and the biological sample.

In some example embodiments, method 400 additionally involves dispensing the reagent, the liquid diluent, and the biological from a dispensing nozzle, wherein the dispensing nozzle is in fluid communication with cap. In some examples, an opening of the dispensing nozzle is configured to dispense the biological sample at a particular flow rate.

In some example embodiments, the biological testing sample of method 400 comprises a mixture of a liquid diluent, a biological sample, and a reagent.

The singular forms of the articles “a,” “an,” and “the” include plural references unless the context clearly indicates otherwise. For example, the term “a compound” or “at least one compound” can include a plurality of compounds, including mixtures thereof.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

What is claimed is:

1. A device for preparing a biological testing sample, wherein the device comprises:
a diluent container comprising:
a diluent chamber comprising a liquid diluent, wherein the diluent chamber is configured to receive a biological sample;
a receiving portion, wherein the receiving portion is in fluid communication with the diluent chamber; and
a first sealant surface, wherein the first sealant surface is proximate to the receiving portion; and
a cap comprising:
a reagent chamber comprising a reagent;
a dispensing nozzle, wherein the dispensing nozzle is in fluid communication with the reagent chamber, and wherein the dispensing nozzle comprises a break-away tab covering an opening of the dispensing nozzle;
an insertion portion, wherein the insertion portion is in fluid communication with the reagent chamber, and wherein the insertion portion is configured to interface with the receiving portion of the diluent chamber; and
a second sealant surface, wherein the second sealant surface is proximate to the insertion portion, and wherein the first sealant surface and the second sealant surface form a liquid seal when the insertion portion is interfaced with the receiving portion of the diluent chamber.

2. The device of claim 1, wherein the diluent chamber is in fluid communication with the reagent chamber when the insertion portion of the reagent chamber is interfaced with the receiving portion of the diluent chamber.

3. The device of claim 1, wherein the biological testing sample comprises a mixture of the liquid diluent, the biological sample, and the reagent.

4. The device of claim 1, wherein the diluent chamber further comprises one or more chambers configured to receive a liquid biological sample.

5. The device of claim 4, wherein the biological sample comprises a liquid biological sample comprising one or more of the following: (i) blood; (ii) urine; (iii) saliva; (iv) fecal matter; (v) secretion; (vi) excretion; (vii) Fine Needle Aspirate (FNA); (viii) lavage fluids; (ix) body cavity fluids; (x) semen; and (xi) bacteria.

6. The device of claim 1, wherein the diluent container is made of a compliant material such that when compressed, when the diluent chamber is in fluid communication with the reagent chamber and the insertion portion of the reagent chamber is interfaced with the receiving portion of the diluent chamber, the biological testing sample is dispensed from the dispensing nozzle.

7. The device of claim 1, wherein the diluent chamber further comprises one or more extraction ribs configured to extract a biological sample.

8. The device of claim 7, wherein the biological sample comprises ear wax.

9. The device of claim 1, wherein the diluent container further comprises a sealant member covering an opening of the receiving portion.

10. The device of claim 1, wherein the liquid diluent has a volume of about 250 μl.

11. The device of claim 1, wherein the reagent comprises a solid reagent.

12. The device of claim 11, wherein the solid reagent comprises a lyophilized reagent.

13. The device of claim 12, wherein the lyophilized reagent comprises one or more quality control beads.

14. The device of claim 12, wherein the lyophilized reagent comprises one or more fluorescent stains.

15. The device of claim 1, wherein the reagent chamber further comprises a reagent retention mechanism.

16. The device of claim 15, wherein the reagent retention mechanism comprises a ring portion inside the reagent chamber.

17. The device of claim 15, wherein the reagent retention mechanism comprises one or more fins inside the reagent chamber.

18. The device of claim 1, wherein the cap further comprises a sealant member covering an opening of the insertion portion.

19. The device of claim 1, wherein the opening of the dispensing nozzle is configured to dispense the biological sample at a particular flow rate.

20. A method for preparing a biological testing sample, the method comprising:
depositing a liquid diluent into a diluent chamber of a diluent container;
depositing a reagent into a reagent chamber of a cap;
receiving a biological sample in the diluent chamber of the diluent container;
inserting an insertion portion of the cap into a receiving portion of the diluent container, wherein the receiving portion comprises a first sealant surface that interfaces with a second sealant surface of the insertion portion, and wherein the first sealant surface and the second sealant surface form a liquid seal when interfaced, and wherein the diluent chamber is in fluid communication with the reagent chamber when the insertion portion of the cap is inserted into the receiving portion of the diluent container; and
after inserting the insertion portion of the cap into the receiving portion of the diluent container, agitating the reagent with the liquid diluent and the biological sample.
